(19) United States
(12) Patent Application Publication
(10) Pub. No.: US 2003/0191776 A1
(43) Pub. Date: Oct. 9, 2003

(54) Media object management

(76) Inventor: Pere Obrador, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/117,033

(22) Filed: Apr. 5, 2002

(51) Int. Cl. G06F 17/00

(52) U.S. Cl. 707/104.1

(57) ABSTRACT

Systems and methods of managing media objects are described. In one aspect, a collection of media objects is accessed, including at least one media file of indexed, temporally-ordered data structures. Links are generated between media objects and respective data structures of the media file, each link being browsable from a given data structure to a linked media object and from the linked media object to the given data structure. The browsable links are stored in one or more media object linkage data structures.

### TECHNICAL FIELD

This invention relates to systems and methods of managing media objects.

### BACKGROUND

Individuals and organizations are rapidly accumulating large collections of digital content, including text, audio, graphics, animated graphics and full-motion video. This content may be presented individually or combined in a wide variety of different forms, including documents, presentations, music, still photographs, commercial videos, home movies, and meta data describing one or more associated digital content files. As these collections grow in number and diversity, individuals and organizations increasingly will require systems and methods for organizing and browsing the digital content in their collections. To meet this need, a variety of different systems and methods for browsing selected kinds of digital content have been proposed.

For example, storyboard browsing has been developed for browsing full-motion video content. In accordance with this technique, video information is condensed into meaningful representative snapshots and corresponding audio content. One known video browser of this type divides a video sequence into equal length segments and denotes the first frame of each segment as its key frame. Another known video browser of this type stacks every frame of the sequence and provides the user with rich information regarding the camera and object motions.

Content-based video browsing techniques also have been proposed. In these techniques, a long video sequence typically is classified into story units based on video content. In some approaches, scene change detection (also called temporal segmentation of video) is used to give an indication of when a new shot starts and ends. Scene change detection algorithms, such as scene transition detection algorithms based on DCT (Discrete Cosine Transform) coefficients of an encoded image, and algorithms that are configured to identify both abrupt and gradual scene transitions using the DCT coefficients of an encoded video sequence are known in the art.

In one video browsing approach, Rframes (representative frames) are used to organize the visual contents of video clips. Rframes may be grouped according to various criteria to aid the user in identifying the desired material. In this approach, the user may select a key frame, and the system then uses various criteria to search for similar key frames and present them to the user as a group. The user may search representative frames from the groups, rather than the complete set of key frames, to identify scenes of interest. Language-based models have been used to match incoming video sequences with the expected grammatical elements of a news broadcast. In addition, a priori models of the expected content of a video clip have been used to parse the clip.

In another approach, U.S. Pat. No. 5,821,945 has proposed technique for extracting a hierarchical decomposition of a complex video selection for video browsing purposes. This technique combines visual and temporal information to capture the important relations within a scene and between scenes in a video, thus allowing the analysis of the underlying story structure with no a priori knowledge of the content. A general model of hierarchical scene transition graph is applied to an implementation for browsing. Video shots are first identified and a collection of key frames is used to represent each video segment. These collections are then classified according to gross visual information. A platform is built on which the video is presented as directed graphs to the user, with each category of video shots represented by a node and each edge denoting a temporal relationship between categories. The analysis and processing of video is carried out directly on the compressed videos.

A variety of different techniques that allow media files to be searched through associated annotations also have been proposed. For example, U.S. Pat. No. 6,332,144 has proposed a technique in accordance with which audio/video media is processed to generate annotations that are stored in an index server. A user may browse through a collection of audio/video media by submitting queries to the index server. In response to such queries, the index server transmits to a librarian client each matching annotation and a media identification number associated with each matching annotation. The librarian client transmits to the user the URL (uniform resource locator) of the digital representation from which each matching annotation was generated and an object identification number associated with each matching annotation. The URL may specify the location of all or a portion of a media file.

### SUMMARY

In one aspect of the invention, a collection of media objects is accessed, including at least one media file of indexed, temporally-ordered data structures. Links are generated between media objects and respective data structures of the media file, each link being browsable from a given data structure to a linked media object and from the linked media object to the given data structure. The browsable links are stored in one or more media object linkage data structures.

In another aspect, the invention features a system comprising a media manager operable to implement the above-described method of managing a collection of media objects.

Other features and advantages of the invention will become apparent from the following description, including the drawings and the claims.

### DESCRIPTION OF DRAWINGS

FIG. 1 is a diagrammatic view of a media management node coupled directly to a set of local media files and coupled indirectly to multiple sets of remote media files over a local area network and a global network infrastructure.

FIG. 2 is a diagrammatic view of a computer system that is programmable to implement a method of managing media objects.

FIG. 3 is a diagrammatic perspective view of a media file of indexed, temporally-ordered data structures and an automatically-generated selection of key data structures.

FIG. 4 is a diagrammatic perspective view of the media file of FIG. 3 after the selection of key data structures has been modified by a user.

FIG. 5 is a diagrammatic perspective view of an indexed media file containing a sequence of full-motion video frames, a selection of keyframes, and a high resolution still photograph.

FIG. 6 is a diagrammatic perspective view of the indexed media file, keyframe selection and high resolution still photograph of FIG. 5, along with multiple user-selected media objects that are linked to respective video frames of the indexed media file.

FIG. 7A is a diagrammatic perspective view of the links connecting the keyframes, the high resolution still photograph, and the media objects to the indexed media file of FIG. 6.

FIG. 7B is a diagrammatic perspective view of a database storing the indexed media file, keyframes, high resolution still photograph, media objects and connecting links of FIG. 7A.

FIG. 8A is a diagrammatic perspective view of a video file mapped into a set of video sequences.

FIG. 8B is a diagrammatic perspective view of a set of video sequences mapped into a common video file.

FIG. 8C is a diagrammatic perspective view of a set of consecutive video sequences mapped into two video files.

FIG. 8D is a diagrammatic perspective view of a set of non-consecutive video sequences mapped into two video files.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

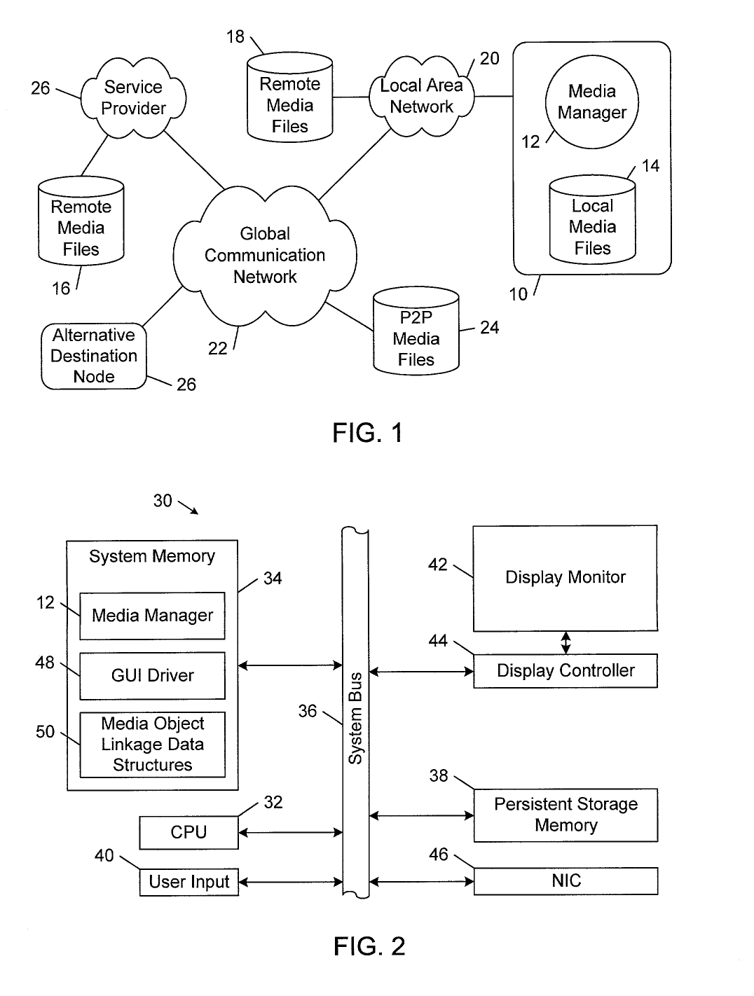

Referring to FIG. 1, in one embodiment, a media management node 10 includes a media manager 12 that is configured to enable all forms of digital content in a selected collection of media objects to be organized into a browsable context-sensitive, temporally-referenced media database. As used herein, the term “media object” refers broadly to any form of digital content, including text, audio, graphics, animated graphics and full-motion video. This content may be packaged and presented individually or in some combination in a wide variety of different forms, including documents, annotations, presentations, music, still photographs, commercial videos, home movies, and meta data describing one or more associated digital content files. The media objects may be stored physically in a local database 14 of media management node 10 or in one or more remote databases 16, 18 that may be accessed over a local area network 20 and a global communication network 22, respectively. Some media objects also may be stored in a remote database 24 that is accessible over a peer-to-peer network connection. In some embodiments, digital content may be compressed using a compression format that is selected based upon digital content type (e.g., an MP3 or a WMA compression format for audio works, and an MPEG or a motion JPEG compression format for audio/video works). The requested digital content may be formatted in accordance with a user-specified transmission format. For example, the requested digital content may be transmitted to the user in a format that is suitable for rendering by a computer, a wireless device, or a voice device. In addition, the requested digital content may be transmitted to the user as a complete file or in a streaming file format.

A user may interact with media manager 12 locally, at media management node 10, or remotely, over local area network 20 or global communication network 22. Transmissions between media manager 12, the user, and the content providers may be conducted in accordance with one or more conventional secure transmission protocols. For example, each digital work transmission may involve packaging the digital work and any associated meta-data into an encrypted transfer file that may be transmitted securely from one entity to another.

Global communication network 22 may include a number of different computing platforms and transport facilities, including a voice network, a wireless network, and a computer network. Media object requests may be transmitted, and media objects replies may be presented in a number of different media formats, such as voice, Internet, e-mail and wireless formats. In this way, users may access the services provided by media management node 10 and the remote media objects 16 provided by service provider 26 and peer-to-peer node 24 using any one of a wide variety of different communication devices. For example, in one illustrative implementation, a wireless device (e.g., a wireless personal digital assistant (PDA)) may connect to media management node 10, service provider 26, and peer-to-peer node 24 over a wireless network. Communications from the wireless device may be in accordance with the Wireless Application Protocol (WAP). A wireless gateway converts the WAP communications into HTTP messages that may be processed by service provider 10. In another illustrative implementation, a voice device (e.g., a conventional telephone) may connect to media management node 10, service provider 26 and peer-to-peer node 24 over a voice network. Communications from the voice device may be in the form of conventional analog or digital audio signals, or they may be formatted as VoxML messages. A voice gateway may use speech-to-text technology to convert the audio signals into HTTP messages; VoxML messages may be converted to HTTP messages based upon an extensible style language (XSL) style specification. The voice gateway also may be configured to receive real time audio messages that may be passed directly to the voice device. Alternatively, the voice gateway may be configured to convert formatted messages (e.g., VoxML, XML, WML, e-mail) into a real time audio format (e.g., using text-to-speech technology) before the messages are passed to the voice device. In a third illustrative implementation, a software program operating at a client personal computer (PC) may access the services of media management node 10 and the media objects provided by service provider 26 and peer-to-peer node 24 over the Internet.

As explained in detail below, media manager 12 enables a user to organize and browse through a selected collection of media objects by means of a set of links between media objects. In general, all media objects may be indexed by any other media object in the selected collection. Each link may be browsed from one media object to a linked media object, and vice versa. The set of links between media objects may be generated by a user, a third party, or automatically by media manager 12. These links are stored separately from the media objects in one or more media object linkage data structures that are accessible by the media manager 12.

Content manager 12 may provide access to a selected digital content collection in a variety of different ways. In one embodiment, a user may organize and browse through a personal collection of a diverse variety of interlinked media objects. In another embodiment, content manager 12 may operate an Internet web site that may be accessed by a conventional web browser application program executing on a user's computer system. The web site may present a collection of personal digital content, commercial digital content and/or publicly available digital content. The web site also may provide additional information in the form of media objects that are linked to the available digital content. Users may specify links to be generated and browse through the collection of digital content using media objects as links into and out of specific digital content files. In an alternative embodiment, a traditional brick-and-mortar retail establishment (e.g., a bookstore or a music store) may contain one or more kiosks (or content preview stations). The kiosks may be configured to communicate with media manager 12 (e.g., over a network communication channel) to provide user access to digital content that may be rendered at the kiosk or transferred to a user's portable media device for later playback. A kiosk may include a computer system with a graphical user interface that enables users to establish links and navigate through a collection of digital content that is stored locally at the retail establishment or that is stored remotely and is retrievable over a network communication channel. A kiosk also may include a cable port that a user may connect to a portable media device for downloading selected digital content.

In embodiments in which a user interacts remotely with media manager 12, the user may store the media object linkage data structures that are generated during a session in a portable storage device or on a selected network storage location that is accessible over a network connection.

Referring to FIG. 2, in one embodiment, content manager 12 may be implemented as one or more respective software modules operating on a computer 30. Computer 30 includes a processing unit 32, a system memory 34, and a system bus 36 that couples processing unit 32 to the various components of computer 30. Processing unit 32 may include one or more processors, each of which may be in the form of any one of various commercially available processors. System memory 34 may include a read only memory (ROM) that stores a basic input/output system (BIOS) containing start-up routines for computer 30 and a random access memory (RAM). System bus 36 may be a memory bus, a peripheral bus or a local bus, and may be compatible with any of a variety of bus protocols, including PCI, VESA, Microchannel, ISA, and EISA. Computer 30 also includes a persistent storage memory 38 (e.g., a hard drive, a floppy drive 126, a CD ROM drive, magnetic tape drives, flash memory devices, and digital video disks) that is connected to system bus 36 and contains one or more computer-readable media disks that provide non-volatile or persistent storage for data, data structures and computer-executable instructions. A user may interact (e.g., enter commands or data) with computer 30 using one or more input devices 40 (e.g., a keyboard, a computer mouse, a microphone, joystick, and touch pad). Information may be presented through a graphical user interface (GUI) that is displayed to the user on a display monitor 42, which is controlled by a display controller 44. Computer 30 also may include peripheral output devices, such as speakers and a printer. One or more remote computers may be connected to computer 30 through a network interface card (NIC) 46.

As shown in FIG. 2, system memory 34 also stores media manager 12, a GUI driver 48, and one or more media object linkage structures 50. Media manager 12 interfaces with the GUI driver 48 and the user input 40 to control the creation of the media object linkage data structures 50. Media manager 12 also interfaces with the GUI driver 48 and the media object linkage data structures to control the media object browsing experience presented to the user on display monitor 42. The media objects in the collection to be linked and browsed may be stored locally in persistent storage memory 38 or stored remotely and accessed through NIC 46, or both.

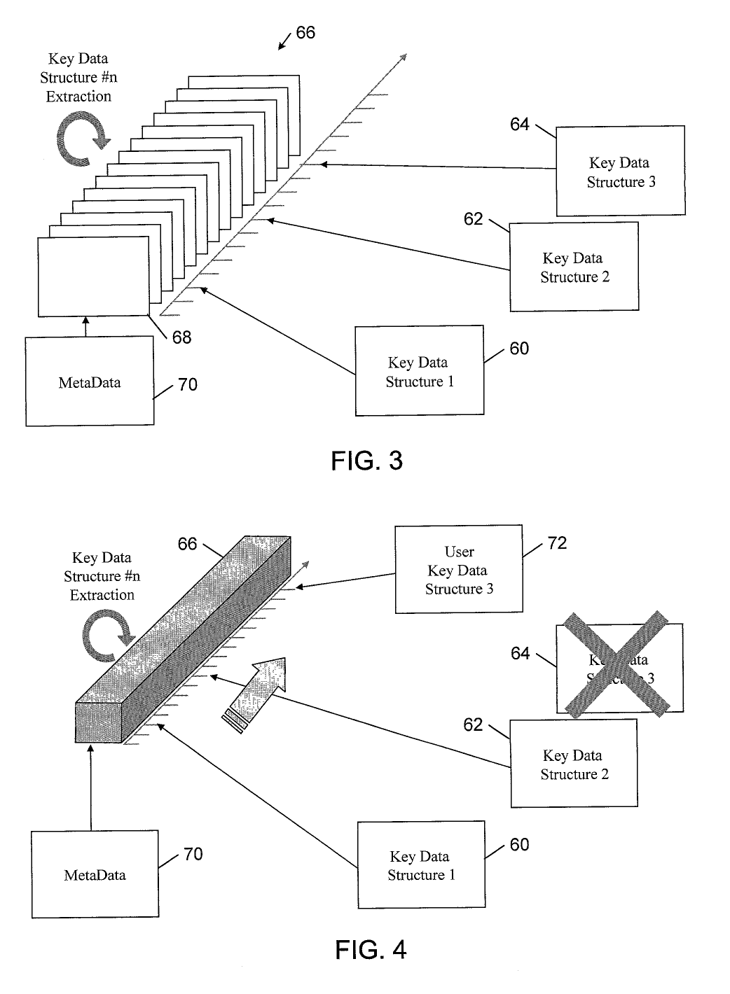

Referring to FIG. 3, in one embodiment, media manager 12 may be configured to automatically generate a selection of key data structures 60, 62, 64 from a media file 66 of indexed, temporally-ordered data structures 68. Media file 66 may correspond to any kind of digital content that is indexed and temporally-ordered (i.e., ordered for playback in a specific time sequence), including frames of a full-motion video, animated graphics, slides (e.g., PowerPoint® slides, text slides, and image slides) organized into a slideshow presentation, and segments of digital audio. Key data structures 60-64 may be extracted in accordance with any one of a variety of conventional automatic key data structure extraction techniques (e.g., automatic keyframe extraction techniques used for full-motion video). Media manager 12 also may be configured to link meta data 70 with the first data structure 68 of media file 66. In this embodiment, each of the media file data structures 68 is associated with an index value (e.g., a frame number or time-stamp number for full-motion video). Each of the links between media objects 60-64, 70 and media file data structures 68 is a pointer between the index value associated with the media file data structure 68 and the address of one of the linked media objects 60-64, 70. Each link is browsable from a given data structure 68 of media file 66 to a media object 60-64, 70, and vice versa. The links may be stored in one or more media object data structures in, for example, an XML (Extensible Markup Language) format.

As shown in FIG. 4, in one embodiment, media manager 12 is configured to modify the initial selection of key data structures in response to user input. For example, in the illustrated embodiment, a user may remove key data structure 64 and add a new key data structure 72. In addition, a user may change the data structure 68 of media file 66 to which key data structure 62 is linked. In this embodiment, the data structures 68 of media file 68 preferably are presented to the user in the graphical user interface as a card stack. In this presentation, the user may select one of the data structures 68 with a pointing device (e.g., a computer mouse) and media manager 12 will present the contents of the selected data structure to the user for review. In other embodiments, the data structures 68 of media file 66 may be presented to the user in an array or one-by-one in sequence.

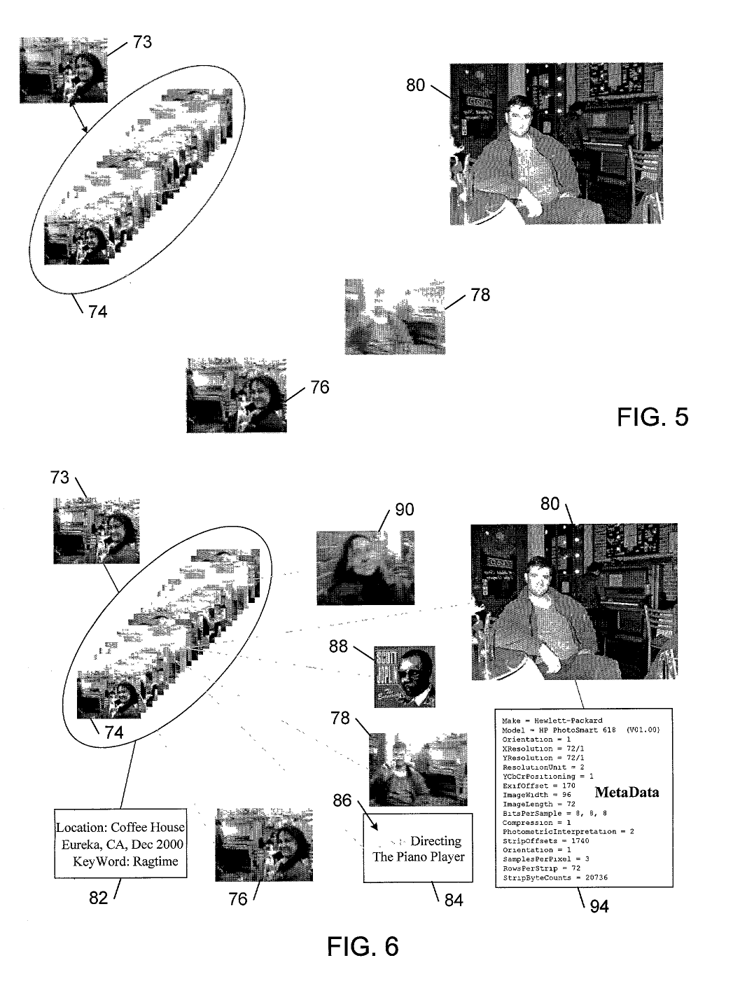

Referring to FIGS. 5 and 6, in one illustrative embodiment, media file 66 corresponds to a video file sequence 73 of full-motion video frames 74. After automatic keyframe extraction and user-modification, two keyframes 76, 78 and a high resolution still photograph 80 are linked to video file 73. As shown in FIG. 6, in addition to modifying the selection of keyframes 76-80, a user may link other media objects to the video frames 74 of media file 66. For example, the user may link a text file annotation 82 to video file 73. The user also may link an XHTML (Extensible HyperText Markup Language) document 84 to the video frame corresponding to keyframe 78. XHTML document 84 may include a hypertext link 86 that contains the URL (Uniform Resource Locator) for another media object (e.g., a web page). The user also may link an audio file 88 to the video frame corresponding to keyframe 80. In the illustrated embodiment, for example, the linked audio file 88 may correspond to the song being played by a person appearing in the associated video keyframe 80. The user also may link a full-motion video file 90 to a frame 92 of video file 73. In the illustrated embodiment, for example, the linked video file 90 may correspond to a video of a person appearing in the associated video frame 92. The user also may link to the video frame corresponding to keyframe 80 a text file 94 containing meta data relating to the associated video frame 80. For example, in the illustrated embodiment, video frame 80 may correspond to a high-resolution still image and meta data file 94 may correspond to the meta data that was automatically generated by the video camera that captured the high-resolution still image.

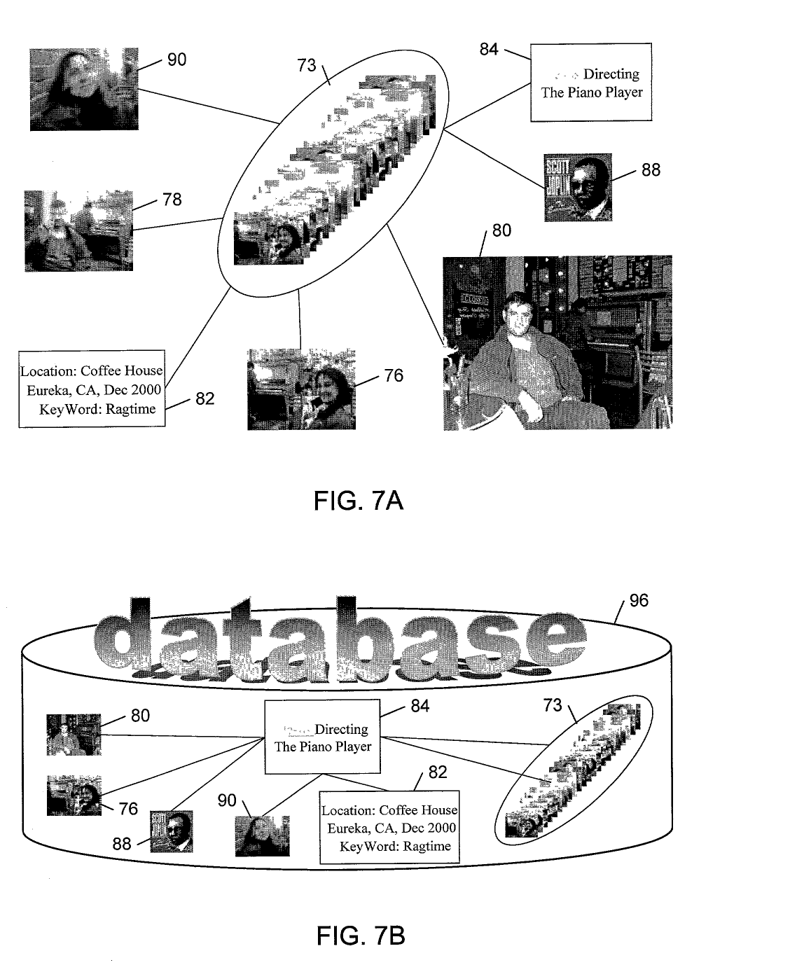

Referring to FIGS. 7A and 7B, in one embodiment, after video file 73 has been enriched with links to other media objects, the resulting collection of media objects and media object linkage data structures may be stored as a context-sensitive, temporally-referenced media database 96. This database 96 preserves temporal relationships and associations between media objects. The database 96 may be browsed in a rich and meaningful way that allows target contents to be found rapidly and efficiently from associational links that may evolve over time. All media objects linked to the video file 73 may share annotations and links with other media objects. In this way, new or forgotten associations may be discovered while browsing through the collection of media objects.

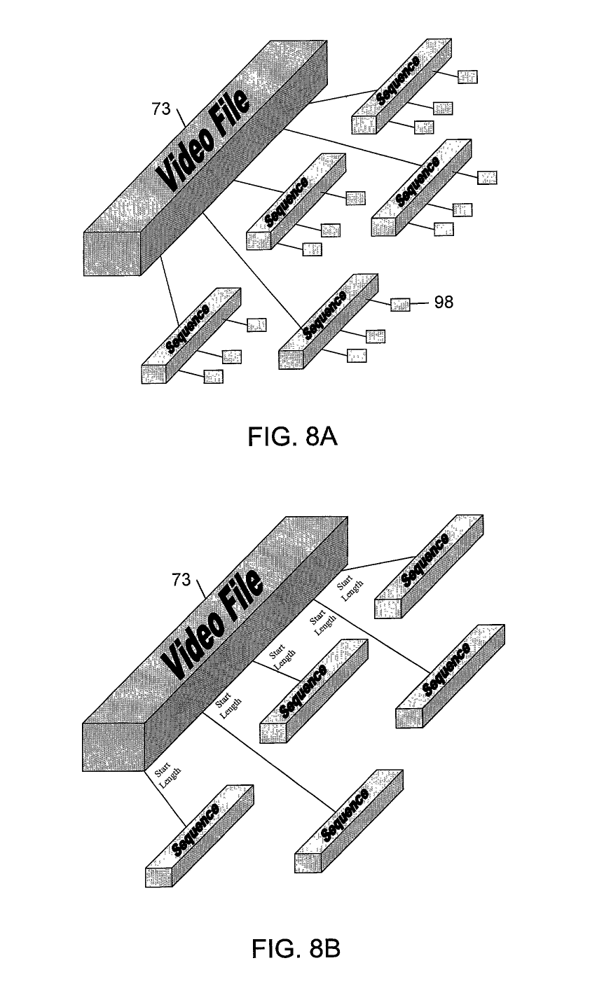

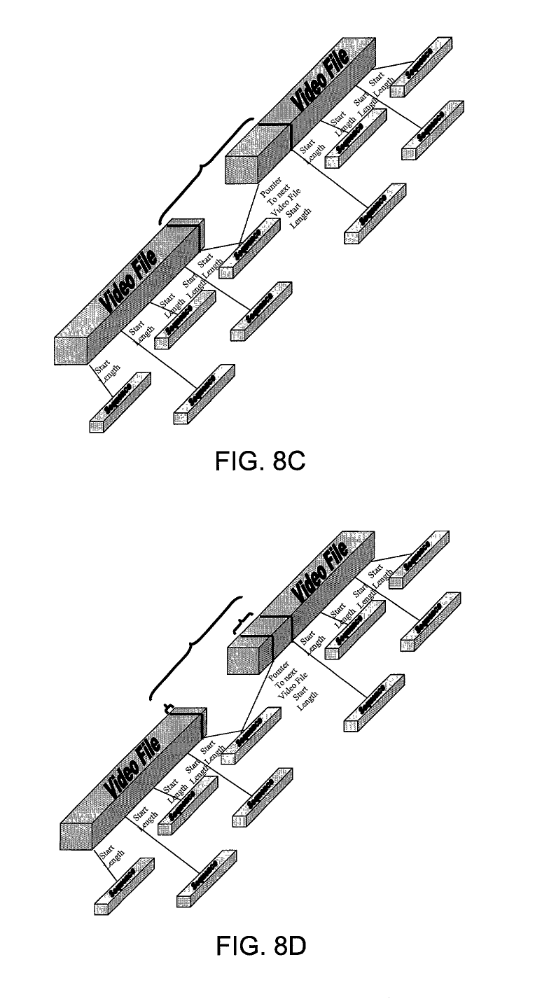

Referring to FIGS. 8A-8D, in some embodiments, all media files in a selected collection are stored only once in data base 96 (FIG. 7B). Each media file (e.g., video file 73) of indexed, temporally-ordered data structures may be split logically into a set of data structure sequences that are indexed with logical links into the corresponding media file. Media objects 98 may be indexed with logical links into the set of data structure sequences, as shown in FIG. 8A. Each data structure sequence link into a media file may identify a starting point in the media file and the length of the corresponding sequence. The data structure sequences may be consecutive, as shown in FIG. 8B, or non-consecutive. In addition, the set of data structure sequences may map consecutively into multiple media files, as shown in FIG. 8C. Alternatively, the set of data structure sequences may be mapped non-consecutively into multiple media files.

The systems and methods described herein are not limited to any particular hardware or software configuration, but rather they may be implemented in any computing or processing environment, including in digital electronic circuitry or in computer hardware, firmware or software. These systems and methods may be implemented, in part, in a computer program product tangibly embodied in a machine-readable storage device for execution by a computer processor. In some embodiments, these systems and methods preferably are implemented in a high level procedural or object oriented programming language; however, the algorithms may be implemented in assembly or machine language, if desired. In any case, the programming language may be a compiled or interpreted language. The media object management methods described herein may be performed by a computer processor executing instructions organized, e.g., into program modules to carry out these methods by operating on input data and generating output. Suitable processors include, e.g., both general and special purpose microprocessors. Generally, a processor receives instructions and data from a read-only memory and/or a random access memory. Storage devices suitable for tangibly embodying computer program instructions include all forms of nonvolatile memory, including, e.g., semiconductor memory devices, such as EPROM, EEPROM, and flash memory devices; magnetic disks such as internal hard disks and removable disks; magneto-optical disks; and CD-ROM. Any of the is foregoing technologies may be supplemented by or incorporated in specially-designed ASICs (application-specific integrated circuits).

Other embodiments are within the scope of the claims.

What is claimed is:

1. A method of managing a collection of media objects, comprising:
accessing a collection of media objects, including at least one media file of indexed, temporally-ordered data structures;
generating links between media objects and respective data structures of the media file, each link being browsable from a given data structure to a linked media object and from the linked media object to the given data structure; and
storing the browsable links in one or more media object linkage data structures.

2. The method of claim 1, wherein media objects comprise one or more of the following: text, audio, graphics, animated graphics, and full-motion video.

3. The method of claim 1, wherein media objects are distributed across one or more computer networks.

4. The method of claim 1, further comprising generating a selection of key data structures by automatically identifying one or more data structures of the media file as key data structures.

5. The method of claim 4, further comprising modifying the selection of key data structures in response to user input.

6. The method of claim 5, wherein modifying the selection of key data structures comprises removing one or more data structures of the media file identified as key data structures.

7. The method of claim 5, wherein modifying the selection of key data structures comprises identifying as key data structures one or more data structures of the multimedia file selected by a user.

8. The method of claim 1, wherein the media objects in the collection are selected by a user.

9. The method of claim 1, wherein the media file comprises a sequence of full-motion video frames each identified by an associated index value.

10. The method of claim 9, further comprising generating a selection of keyframes by automatically identifying one or more video frames as keyframes.

11. The method of claim 10, further comprising modifying the selection of keyframes in response to user input.

12. The method of claim 11, wherein modifying the selection of keyframes comprises removing one or more video frames identified as keyframes.

13. The method of claim 11, wherein modifying the selection of keyframes comprises identifying as keyframes one or more video frames selected by a user.

14. The method of claim 1, wherein links are generated in response to user input.

15. The method of claim 14, wherein a link is generated in response to a user's selection of a media object and a data structure of the media file to be linked.

16. The method of claim 15, further comprising providing a graphical user interface enabling a user to select for linking media objects and respective data structures of the multimedia file.

17. The method of claim 16, wherein media objects are represented as graphical images in the graphical user interface.

18. The method of claim 16, wherein links are displayed as lines connecting linked media objects and respective data structures of the media file.

19. The method of claim 1, wherein links are browsable from a given media object to any media object linked to the given media object.

20. The method of claim 1, further comprising generating multiple links from a given media object to a respective number of other media objects.

21. The method of claim 20, wherein each media object in the collection is linkable to any other media object in the collection.

22. The method of claim 1, wherein media object linkage data structures are stored independently of media objects.

23. The method of claim 1, further comprising generating from the media file multiple media objects corresponding to overlapping or non-overlapping sequences of temporally-ordered data structures of the media file.

24. The method of claim 23, wherein generating multiple media objects comprises generating data structures linking the generated media objects to corresponding portions of the media file.

25. A system for managing a collection of media objects, comprising a media manager operable to:
access a collection of media objects, including at least one media file of indexed, temporally-ordered data structures;
generate links between media objects and respective data structures of the media file, each link being browsable from a given data structure to a linked media object and from the linked media object to the given data structure; and
store the browsable links in one or more media object linkage data structures.

26. The system of claim 25, wherein media objects comprise one or more of the following: text, audio, graphics, animated graphics, and full-motion video.

27. The system of claim 25, wherein media objects are distributed across one or more computer networks.

28. The system of claim 25, wherein the media manager is further operable to generate a selection of key data structures by automatically identifying one or more data structures of the media file as key data structures.

29. The system of claim 28, wherein the media manager is further operable to modify the selection of key data structures in response to user input.

30. The system of claim 29, wherein the media manager is operable to modify the selection of key data structures by removing one or more data structures of the media file identified as key data structures.

31. The system of claim 29, wherein the media manager is operable to modify the selection of key data structures by identifying as key data structures one or more data structures of the multimedia file selected by a user.

32. The system of claim 25, wherein the media objects in the collection are selected by a user.

33. The system of claim 25, wherein the media file comprises a sequence of full-motion video frames each identified by an associated index value.

34. The system of claim 33, wherein the media manager is further operable to generate a selection of keyframes by automatically identifying one or more video frames as keyframes.

35. The system of claim 34, wherein the media manager is further operable to modify the selection of keyframes in response to user input.

36. The system of claim 35, wherein the media manager is operable to modify the selection of keyframes by removing one or more video frames identified as keyframes.

37. The system of claim 35, wherein the media manager is operable to modify the selection of keyframes by identifying as keyframes one or more video frames selected by a user.

38. The system of claim 25, wherein links are generated in response to user input.

39. The system of claim 38, wherein a link is generated in response to a user's selection of a media object and a data structure of the media file to be linked.

40. The system of claim 39, wherein the media manager is further operable to provide a graphical user interface enabling a user to select for linking media objects and respective data structures of the multimedia file.

41. The system of claim 40, wherein media objects are represented as graphical images in the graphical user interface.

42. The system of claim 40, wherein links are displayed as lines connecting linked media objects and respective data structures of the media file.

43. The system of claim 25, wherein links are browsable from a given media object to any media object linked to the given media object.

44. The system of claim 25, wherein the media manager is further operable to generate multiple links from a given media object to a respective number of other media objects.

45. The system of claim 44, wherein each media object in the collection is linkable to any other media object in the collection.

46. The system of claim 25, wherein media object linkage data structures are stored independently of media objects.

47. The system of claim 25, wherein the media manager is further operable to generate from the media file multiple media objects corresponding to overlapping or non-overlapping sequences of temporally-ordered data structures of the media file.

48. The system of claim 47, wherein the media manager is operable to generate multiple media objects by generating data structures linking the generated media objects to corresponding portions of the media file.
